(19) United States
(12) Patent Application Publication
(10) Pub. No.: US 2011/0226539 A1
(43) Pub. Date: Sep. 22, 2011

(54) VEHICLE WITH REMOVABLE AUXILIARY POWER SYSTEM

(76) Inventors: Michael A. HUSS, Port Orange, FL (US); Robert D. Vollers, Flemington, NJ (US)

(21) Appl. No.: 12/725,188

(22) Filed: Mar. 16, 2010

(51) Int. Cl. B60K 6/20; B60K 1/04; B60K 8/00

(52) U.S. Cl. 180/65.21; 180/65.1; 180/54.1; 903/904

(57) ABSTRACT

An electric and hybrid vehicle configuration with removable auxiliary power supply is disclosed which provides a flexible configuration for, on the one hand, allowing on demand increased range and additional power for accessories and/or increased performance when the auxiliary power supply is easily inserted in the vehicle to charge the battery in an electric vehicle and on the other hand, allowing for weight reduction and increased storage capacity or increased battery capacity when the power supply is removed. In another embodiment, the removable auxiliary power supply may drive the vehicle either separately or in conjunction with the charging of the vehicle main battery to thereby provide a hybrid vehicle configuration.

### BACKGROUND OF THE INVENTION

1. Field of the Invention

The present invention relates to electric and hybrid vehicles and particularly to auxiliary power systems for the vehicles.

2. Description of the Background Art

The popularity of alternatively powered vehicles has led to the building and patenting of numerous systems involving electric and hybrid vehicles. Each of these types comes with inherent disadvantages. Electric vehicles primary drawback is their limited range with weight/cost penalties as battery capacity increases and hybrid vehicles main disadvantage is the additional weight of the hybrid power supply when not required such as on short trips well within the range of the battery capacity. Normal commutes in the United States average approximately 35 miles which could be accomplished economically within the range of many batteries so that the unnecessary weight of the power supply of a hybrid vehicle serves as a hindrance for such distances and occupies useful storage space in the vehicle. The modular hybrid power supply address the lack of recharging infrastructure in the market and will greatly improve consumer acceptance of electric vehicles by making them feasible as a primary vehicle. Additional battery packs and/or the hybrid power supply could be sold optionally and make the vehicle flexible and adaptable to the consumer's needs.

Although prior art discloses a removable hybrid system, there is no known prior art which addresses the aforementioned dichotomy between a lack of range for battery operation alone and unnecessary weight in hybrid vehicles for short range driving in a manner which economically and practically combines the advantages of battery operation and hybrid operation. Examples of prior art removable systems include (1) Mennenga US 2003/006009A1 which describes a hybrid system with a portable generator supplying power to an electric drive motor that is connected to the drive wheels without the use of batteries, an inverter, or an electric control unit; (2) Harris, Amico US 2006/0162973 A1 describes a removable power supply module having the components of an electric power system including the battery and controller. The removable power supply is designed to fit within the battery compartment so that the machine can be converted to hybrid power by replacing the normal vehicle battery; (3) Ortenheim U.S. Pat. No. 5,251,721 describes a vehicle with a compartment adapted to receive a removable fuel propulsion system , a transmission and a connection to the drive axel of the vehicle to thereby construct a duel propulsion system connected to the drive wheels; (4) Harris US 2009/0079384 discloses a plug-in charger and a system that rearranges battery cells for two different modes with one mode being a series connection for operation of the vehicle and the other mode being a parallel connection for charging the batteries with a 12 volt charge during non-operation of the vehicle; (5) Harris US 2009/0078481 which describes a hybrid vehicle with multiple different modular battery units which can be added or removed and which each can be associated with a separate electric motor; and (6) Peugeot Shows Three-wheel drive Hybrid Scooter containing the Hybrid3 Evolution, Green Car Congress 11 Nov. 2009,(http://www.greencarcongress.com/2009/11/hybrid3-evolution-20091111.html) shows a scooter with a separate drive system for each of its two wheels.

Neither the above disclosures nor other applications describing duel or multiple power systems describe hybrid systems which are readily removable and capable of charging the battery and/or supply power directly to the drive motor(s) as required. Each prior art removable power supply detailed above, although appropriate for their intended use, include unnecessary complexity for a simple hybrid vehicle. There is thus a need for a hybrid system that is easily removable, preferable without the use of tools or equipment.

### SUMMARY OF THE INVENTION

It is therefore an object of the present invention to provide an electric vehicle with the facilities to accept the intermittent instillation of a portable power generator for the purpose of supplying energy to the batteries to extend the range of the vehicle and or to accommodate high energy demand accessories such as headlights and air conditioning which can be easily installed and removed.

It is also an object of this invention to provide interchangeable hybrid power supplies for example an internal combustion engine coupled with a generator, a fuel cell system as well as additional modular battery packs.

It is also an object to provide a storage compartment for the vehicle when the portable power supply is removed from the vehicle.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a block diagram of a vehicle with a compartment for housing a removable power generator or additional battery packs as required by the user;

FIG. 2 is a block diagram illustrating one embodiment of the compartment of FIG. 1 containing the removable power generator and/or extra battery packs;

FIG. 3 is a block diagram illustrating another embodiment of the compartment of FIG. 1 containing the removable power generator; and

FIG. 4 is a block diagram illustrating connection of a removable power generator to the non-driven wheels of a vehicle.

### DETAILED DESCRIPTION

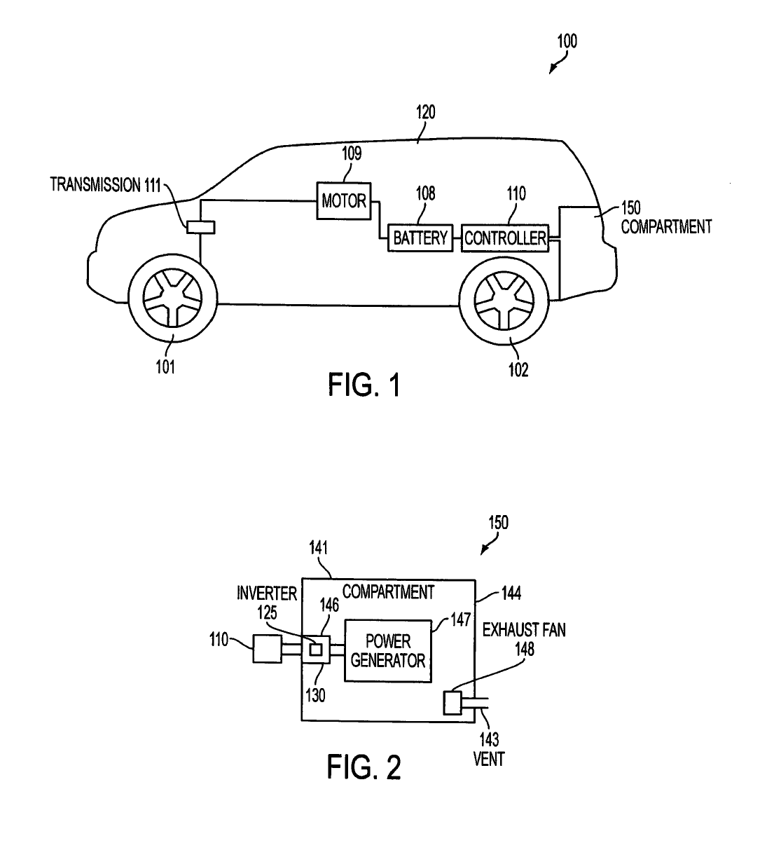

An electric vehicle illustrated in FIG. 1 is structured and modified to enable the use of a removable power generator system. The vehicle 100 includes wheels 101 and 102. In the illustration the wheels 101 are the “driven” wheels as they are shown connected to the battery 108. Wheels 101 use the power of battery 108 to drive the electric motor 109 and transmission 111. While only two wheels are shown as driven in the embodiment of FIG. 1, it should be appreciated that all four wheels could be driven and that a different number of wheels could be driven depending on the type of vehicle. The vehicle 100 includes a compartment 150 separate from the remainder of the interior 120. It is the compartment 150 which serves as the container for supplementing the power of the vehicle through use of a hybrid system and/or battery packs isolated from the passenger compartment and providing power through a controller 110 which functions to regulate charging of battery 108 and controls the power to the electric motor.

FIG. 2 shows an embodiment of a compartment 150 with a portable power generator/alternator 147 which could include a fuel cell or other auxiliary generator. The compartment 150 of FIG. 2 has one side 141 abutting the interior of vehicle 100 and another side 144 abutting the exterior of the vehicle 100. The compartment 144 includes a ventilating system with exhaust fan 148 and vent 143 which functions to remove excess heat and exhaust gasses from the portable power generator 147 to the exterior of the vehicle100. The compartment 150 also includes a connection arrangement 146 for electrically and mechanically attaching and maintaining the portable power generator 147 securely within the compartment 150. The connection arrangement includes an inverter 125 and a brace or strap 130. The inverter 125 converts standard voltage of the removable power generator to the required voltage of the controller 110 and battery 108 so that a connection could be, for instance, a household 115v plus as is required for an off the shelf portable generator or could be a spade or other type of connector positioned for automatic connection to a custom made generator accurately positioned for attachment to power and air conduits and/or fuel supply. The power attachments would be automatically covered when not connected to the generator 147. The brace or strap 130 serves to detachably affix the auxiliary power supply 147 to the vehicle 100 and could be a hand operated clamp or clamps or straps around and or over the generator 147 and latched in place.

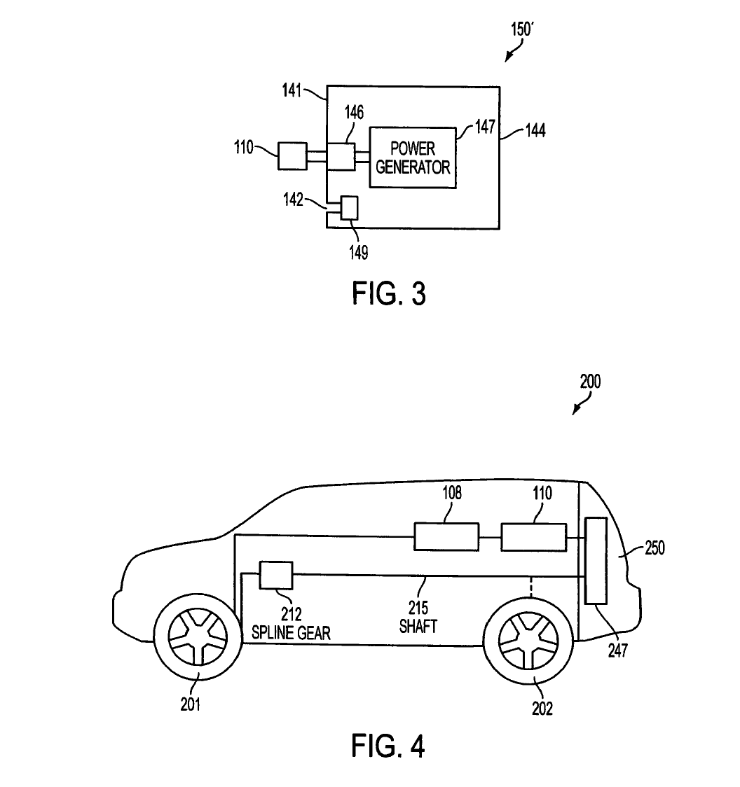

The compartment 150′ of FIG. 3 details an alternate embodiment wherein the excess heat of the portable power generator is fed inside the vehicle in order to heat the vehicle passenger compartment or supply air to a window defogger. Fan 149 and vent 142 feed excess heat from power generator 147 through the side 141 of compartment 150′ to the interior of the vehicle 100. This could allow for water cooling providing a more efficient engine. The remaining features of FIG. 3 correspond to those described in conjunction with the FIG. 2 embodiment.

The embodiment of FIG. 1 with either of the compartments 150 or 150′ of FIG. 2 or 3 provide essentially a supplemental charging system for battery 108 to address the prior disadvantage of electric vehicles regarding their limited range. With the addition of the portable power generator 147 and the supplying of energy to the battery 108 the range of the vehicle 100 is extended and for the vehicle is better able to accommodate high energy demand accessories such as headlights and air conditioning. Furthermore because of the removability of the power supply 147, when energy demands for the vehicle are low such as driving short distances within the capability of the battery, the added weight and expense of the power supply is not needed and the compartment may be used for storage or additional battery capacity depending on user needs.

Another embodiment of the present invention is illustrated in FIG. 4 where a vehicle 200 can be converted into a hybrid vehicle with the addition of a power generator 247 which can be an internal combustion genset (distributed generator system) or a fuel cell designed to both charge the battery 108 in a manner similar to the FIG. 1 embodiment and also power the wheel or wheels 201. With such a custom power generator 247, a drive shaft 215 from the generator is detachably connected by, for example, a spline gear 212 to an axel of wheel or wheels 201. Additionally it is also possible to attach the axel by a pulley to a single wheel, to provide a backup means of vehicle propulsion. Alternatively and/or additionally, as shown by the dotted line from the drive shaft 215 to the wheel 202, the portable power generator equipped with a Power Take Off could be detachably mechanically connected by a spline gear such as the spline gear 212 to vehicle wheels 202 which are not the primary drive wheels of the vehicle 200 to provide an additional and backup drive system including a hydraulically driven system.

As a further alternative, the system of FIG. 4 could be structured as a battery operated vehicle where the battery or a portion of the batteries are replaced by the power generator to drive the vehicle when a user requires increased range and/or passenger comfort features which use more energy. Also the battery 108 could be used in conjunction with a modular battery in the compartments 250 which modular battery is replaced by the a modular power supply providing the same discussed advantages as range and passenger comfort.

The invention being thus described, it will be obvious that the same may be varied in many ways, Such variations are not to be regarded as a departure form the spirit and scope of the invention, and all such modifications as would be obvious to one skilled in the art are to be included within the scope of the following claims.

What is claimed is:

1. An electric vehicle, comprising:
a plurality of wheels;
a body and a frame;
a removable auxiliary power supply;
a compartment within the body dimensioned to accommodate said removable auxiliary power supply;
a device for temporarily affixing said removable auxiliary power supply to said compartment;
a battery;
a battery controller; and
a device for electrically connecting said battery controller to an output of said removable auxiliary power supply wherein said output provides an electrical discharge to said battery controller.

2. The vehicle according to claim 1 wherein the device for electrically connecting said battery controller to an output of said removable auxiliary power supply includes a 115 volt household plug.

3. The vehicle according to claim 1 wherein the device for temporarily affixing said removable auxiliary power supply to said compartment is a strap and latch or cover.

4. The vehicle according to claim 1 wherein the device for electrically connecting said battery controller to an output of said removable auxiliary power supply includes a connector positioned to automatically accept a corresponding connector on the auxiliary power supply as the auxiliary power supply is set in place.

5. The vehicle according to claim 1 wherein said removable auxiliary power supply is a fuel cell.

6. The vehicle according to claim 1 wherein said compartment includes a device for venting heat generated by said removable auxiliary power supply to the exterior of said vehicle.

7. The vehicle according to claim 1 wherein said compartment includes a device for venting heat generated by said removable auxiliary power supply to the interior of said vehicle.

8. The vehicle according to claim 1 wherein said removable auxiliary power supply is an internal combustion engine coupled with an electric generator and a device for discharging exhaust of the internal combustion engine to the exterior of the vehicle.

9. The vehicle according to claim 1 further including one of a spline gear, transmission or torque converter and a drive shaft wherein said drive shaft is connected to another output of said removable auxiliary power supply to drive at least one of said plurality of wheels.

10. The vehicle according to claim 9 wherein said removable auxiliary power supply is an internal combustion engine.

11. The vehicle according to claim 9 wherein said removable auxiliary power supply is a distributed generator system.

12. A vehicle, comprising:
a plurality of wheels including at least one driven wheel and at least one non-driven wheel;
a body and a frame;
a removable auxiliary power supply;
a device for connecting the removable auxiliary power supply to the at least one non-driven wheel thereby providing a dual propulsion system.

13. The vehicle of claim 12 wherein the removable auxiliary power supply is an internal combustion engine coupled to an electric generator.

14. The vehicle according to claim 13 wherein the internal combustion engine is coupled to said non-driven wheel by a structure including a spline gear and a drive shaft or hydraulic drive.

15. The vehicle according to claim 13 wherein the internal combustion engine is coupled to said non-driven wheel by a structure including a belt and pulley system.

16. The vehicle according to claim 13 wherein the internal combustion engine is coupled to said non-driven wheel by a structure including a sprocket and chain system.

17. The vehicle of claim 12 wherein the removable auxiliary power supply is a standard power generator.

18. The vehicle according to claim 1 wherein the device for electrically connecting said battery controller to an output of said removable auxiliary power supply includes a standard plug adapted for use with one of a plurality of voltages.

19. The vehicle according to claim 9 wherein said drive shaft is hydraulically driven.
